(19) United States
(12) Patent Application Publication
(10) Pub. No.: US 2025/0308232 A1
(43) Pub. Date: Oct. 2, 2025

(54) ESTIMATING CROP GROWTH BASED ON INTERFEROMETRIC SYNTHETIC APERTURE RADAR

(71) Applicant: Microsoft Technology Licensing, LLC, Redmond, WA (US)

(72) Inventors: Peder Andreas OLSEN, Cortlandt Manor, NY (US); Suraj Sanjay JOG, Bellevue, WA (US); Vaishnavi Nattar RANGANATHAN, Woodinville, WA (US); Nissanka Arachchige Bodhi PRIYANTHA, Redmond, WA (US); Roberto DE MOURA ESTEVAO FILHO, Teresopolis (BR); Ranveer CHANDRA, Kirkland, WA (US); Debvrat VARSHNEY, Baltimore, MD (US); Zerina KAPETANOVIC, Seattle, WA (US)

(21) Appl. No.: 18/617,640

(22) Filed: Mar. 26, 2024

(51) Int. Cl. G06V 20/10; G06V 10/70; G06V 20/13

(52) U.S. Cl. CPC G06V 20/188; G06V 10/70; G06V 20/13

(57) ABSTRACT

A computerized method estimates crop growth in a geographic area using satellite-collected synthetic aperture radar (SAR) data. SAR data of the geographic area is obtained from a plurality of satellite passes by one or more satellites. The obtained SAR data is processed into coherence data and interferometric data. The processed data is associated with a comparison between a first SAR data subset from a first satellite pass of the plurality of satellites passes and a second SAR data subset from a second satellite pass of the plurality of satellite passes. The processed data is provided to a trained crop growth estimation model and a crop growth prediction associated with the geographic area is generated using the trained crop growth estimation model. In some examples, the obtained SAR data is processed into additional data types, such as amplitude data and/or polarimetric SAR data.

### BACKGROUND

Satellite-based radar enables measurements, such as seismological ground shifts, to be collected around the globe in a highly efficient manner. However, measuring the growth of crops in fields using existing technology is difficult due to sensitivity to rain, wind, and/or crop growth that exceeds radar wavelength between satellite passes.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for estimating crop growth in a geographic area using satellite-collected synthetic aperture radar (SAR) data is described. SAR data of the geographic area is obtained from a plurality of satellite passes by one or more satellites. The obtained SAR data is processed into coherence data and interferometric data. The processed data is associated with a comparison between a first SAR data subset from a first satellite pass of the plurality of satellites passes and a second SAR data subset from a second satellite pass of the plurality of satellite passes. The processed data is provided to a trained crop growth estimation model and a crop growth prediction associated with the geographic area is generated using the trained crop growth estimation model.

### BRIEF DESCRIPTION OF THE DRAWINGS

The present description will be better understood from the following detailed description read considering the accompanying drawings, wherein:

FIG. 1 is a block diagram illustrating an example system for collecting radar data from a geographic location using a satellite and an associated synthetic aperture;

FIG. 2 is a block diagram illustrating an example system for generating a crop growth prediction based on SAR data;

FIG. 3 is a diagram illustrating a comparison of example data collected by a first satellite S1 and a second satellite S2;

FIG. 4 is a diagram illustrating example geometry of the reflection of signals off of the vertical wall of a structure, such as a silo or other farm building;

FIG. 5 is a flowchart illustrating an example method for generating a crop growth prediction using SAR data;

FIG. 6 is a diagram illustrating a structure of an example Convolutional Neural Network (CNN) for operation as a feature change estimation model; and

FIG. 7 illustrates an example computing apparatus as a functional block diagram.

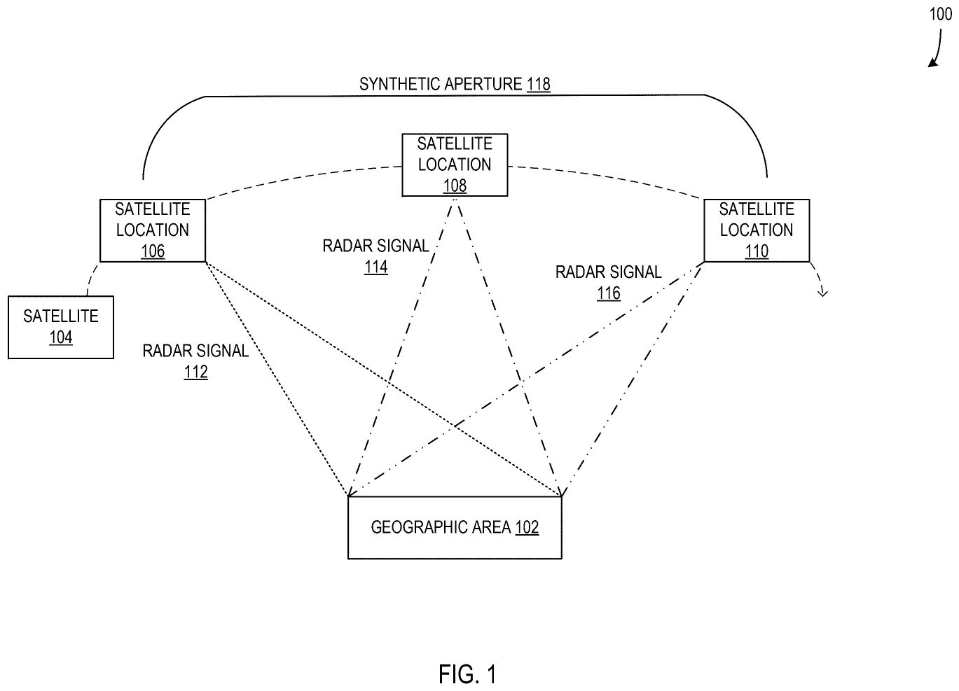

Corresponding reference characters indicate corresponding parts throughout the drawings. In FIGS. 1 to 7, the systems are illustrated as schematic drawings. The drawings may not be to scale. Any of the figures may be combined into a single example or embodiment.

### DETAILED DESCRIPTION

Aspects of the disclosure provide systems and methods for using synthetic aperture radar (SAR) data collected by satellites to estimate the growth of crops in a geographic location over time. One or more satellites travel in range of the geographic location and emit radar signals at the geographic location. The satellites collect reflected radar signals from the geographic location and provide that radar data for use in the described systems and methods. The data collected from several different points along a satellite path are combined to be used as SAR data, substantially improving the effective aperture of the satellites, which in turn increases the accuracy of the data. The SAR data from multiple satellite passes is processed into coherence data, interferometric SAR (InSAR) data, and/or other types of processed data, such as amplitude data and/or polarimetric SAR (PolSAR) data. The processed data is provided as input to a neural network model that has been trained to generate a crop growth prediction based on input processed SAR data. Further, in some examples, the described model is trained using ground truth data for the growth of crops measured with a low flying unmanned aerial system (UAS) using light detection and ranging (LIDAR).

The disclosure operates in an unconventional manner at least by combining the collected radar data as SAR data. The use of the synthetic aperture techniques substantially improves the resolution of the radar image collected by the satellites, thereby enabling measurements of crop growth to be performed at the scale and precision that is required.

Further, the disclosure describes the use of InSAR, PolSAR, and the like. The variety of types of processed data enables the neural network model to identify complex patterns in the data related to the growth of crops and thereby improve the accuracy and precision of the generated crop growth predictions. Additionally, the disclosure describes the use of coherence values for generating weights that are applied to entries of interferometric data. The generated weights are used by the neural network model to appropriately control the degree to which each interferometric data entry affects the crop growth predictions. This enables the disclosure to make use of all collected data while ensuring that “noisy” data is not overvalued by the neural network model. Further, the disclosure uses a method for calculating coherence between a pair of satellite passes by multiplying the coherence of pairs of satellite passes that occurred between the pair being analyzed. This assumption improves the computational efficiency and reduces the computing resource costs of the coherence value calculation.

The disclosure operates to capture the degree of change in the target geographic area, as well as the specific amount of change toward the satellite (e.g., vertical growth) using coherence and interferometry, respectively. Further, the described neural network is trained to make accurate predictions despite issues that can arise with measuring crops or the like with satellites, such as movement of the crops due to wind that does not contribute to the crop growth.

The disclosure calculates coherence values and processes obtained SAR data into interferometric data, amplitude data, polarimetric data, and/or other types of processed data in order to generate relevant input for the trained CNN. Through the use of the several types of processed data, data patterns that are indicative of crop growth in a target geographic area are identified by the trained CNN and crop growth predictions are then generated therefrom. The use of the processed input data with the trained CNN data provides improved accuracy in crop growth predictions compared to other SAR data analyses because the CNN is trained to control for artifacts and/or noise in the SAR data. Further, the use of the CNN enables efficient use of processing and other system resources compared to other analysis methods.

FIG. 1 is a block diagram illustrating an example system 100 for collecting radar data from a geographic area 102 using a satellite 104 and an associated synthetic aperture 118. In some examples, the satellite 104 travels in an orbit around the planet or body (e.g., Earth) upon which the geographic area 102 is located. As the satellite 104 travels within radar range of the geographic area 102, the satellite 104 emits radar signals 112-116 toward the geographic area 102 and captures the resulting radar signals reflected off of the geographic area 102, wherein comparing the emitted radar signals and the reflected radar signals enables the system 100 to measure features of the geographic area 102 (e.g., a current height or other state of crops growing in the geographic area 102, roughness of the geographic area 102, composition of the geographic area 102, and/or topography of the geographic area 102).

Further, in some examples, the satellite 104 emits a radar signal 112 from a satellite location 106 at the geographic area 102 and captures an associated reflected radar signal. Later along that pass of the satellite 104, the satellite 104 emits a radar signal 114 from a satellite location 108 at the geographic area 102 and captures an associated reflected radar signal. Later, along that pass of the satellite 104, the satellite 104 emits a radar signal 116 from a satellite location 110 at the geographic area 102 and captures an associated reflected radar signal. By combining the collected radar data, the resolution or precision of the resulting radar image is increased as if the satellite 104 used an aperture of the size of the synthetic aperture 118 (e.g., based on the distance between satellite location 106 and satellite location 110). The radar data collected by the satellite 104 includes synthetic aperture radar (SAR) data as described herein. It should be understood that, in different examples and/or on different satellite passes of the satellite 104, the satellite 104 uses more, fewer, or different satellite locations to collect satellite data without departing from the description.

Additionally, in some examples, the satellite 104 and/or the system 100 in general is configured to perform motion compensation processes on the collected radar data to account for the motion of the satellite 104 with respect to the geographic area 102. This compensation enables the system 100 to synthesize the large synthetic aperture 118 as described herein.

Further, in some examples, the satellite 104 moves along multiple passes in range of the geographic area 102. The satellite data collected by the satellite 104 along those multiple passes is combined and/or compared, such that changes occurring in the geographic area 102 over time between satellite passes can be observed and/or measured (e.g., changes in crop height of crops in the geographic area 102). Additionally, or alternatively, in some examples, multiple satellites 104 move in passes in range of the geographic area 102 and collect satellite data associated with the geographic area 102 as described herein. That collected satellite data, along with location data and time data of the satellites 104 passing near the geographic area 102, is used to observe and/or measure changes that occur in the geographic area 102.

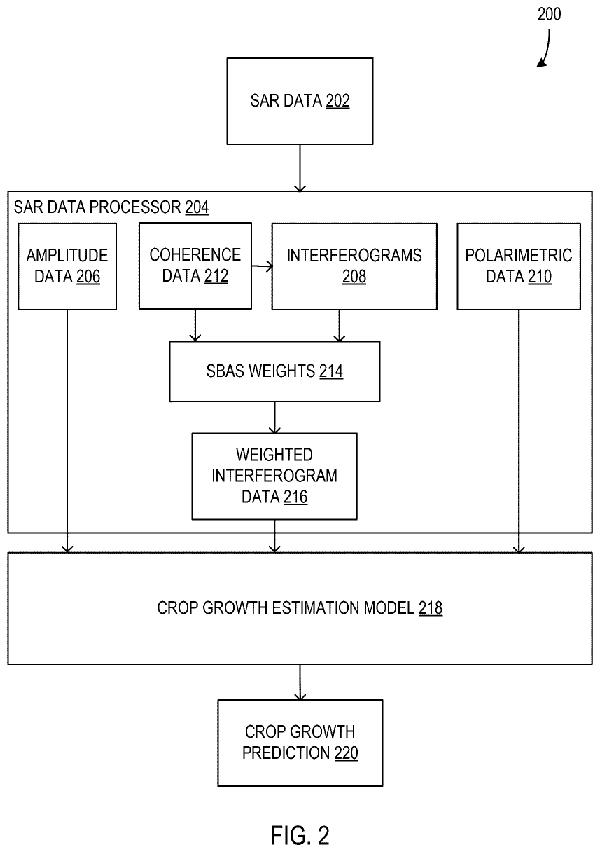

FIG. 2 is a block diagram illustrating an example system 200 for generating a crop growth prediction 220 based on SAR data 202. In some examples, the SAR data 202 is captured and/or collected by satellites passing near a geographic area, such as satellites 104 passing near geographic area 102 of FIG. 1. In some examples, the SAR data 202 is single look complex (SLC) SAR data, such that the SAR data includes the magnitude and the phase of the signal. Further, in some examples, the SAR data processor 204 is configured to generate amplitude data 206, interferograms 208, and/or polarimetric data 210 using the SAR data 202. The generated data 206-212 is then provided to a crop growth estimation model 218 as input. The crop growth estimation model 218 is trained to generate the crop growth prediction 220 using the provided input data as described herein. Additionally, or alternatively, in some examples, interferograms 208 are generated using coherence data 212. Small baseline subset (SBAS) weights 214 are determined using the coherence data 212 to form weighted interferogram data 216. In some such examples, weighted interferogram data 216 is provided to the crop growth estimation model 218 as input. It should be understood that, in some examples, the crop growth estimation model 218 is given more, fewer, or different types of processed SAR data without departing from the description.

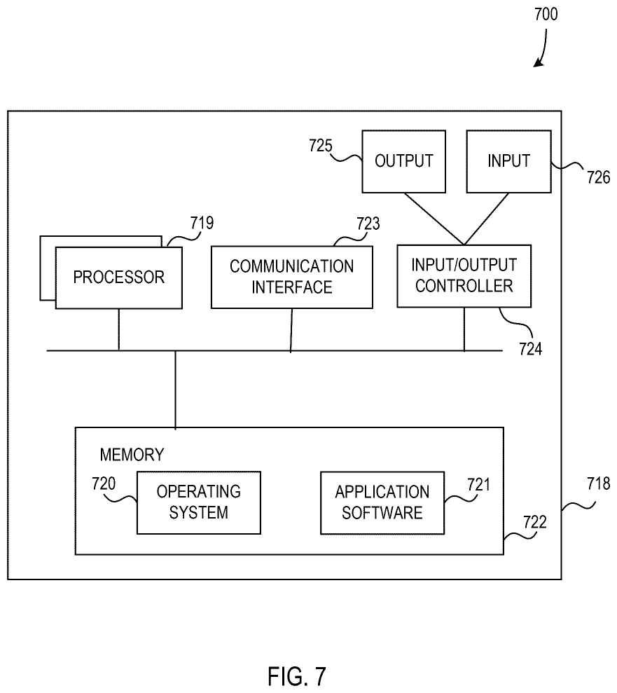

Further, in some examples, the system 200 includes one or more computing devices (e.g., the computing apparatus of FIG. 7) that are configured to communicate with each other via one or more communication networks (e.g., an intranet, the Internet, a cellular network, other wireless network, other wired network, or the like). In some examples, entities of the system 200 are configured to be distributed between the multiple computing devices and to communicate with each other via network connections. For example, SAR data processor 204 is executed on a first computing device and the crop growth estimation model 218 is located on a second computing device within the system 200. The first computing device and second computing device are configured to communicate with each other via network connections. Alternatively, in some examples, other components of the SAR data processor 204 (e.g., elements that generate the interferograms 208 and elements that determine the SBAS weights 214) are executed on separate computing devices and those separate computing devices are configured to communicate with each other via network connections during the operation of the SAR data processor 204. In other examples, other organizations of computing devices are used to implement system 200 without departing from the description.

In some examples, the SAR data processor 204 processes the SAR data 202 to generate amplitude data 206. The amplitude data 206 includes data referring to the strength and/or intensity of the radar signal reflected back to the collecting satellite 104. The strength of this reflected signal is influenced by numerous factors of the target geographic area 102, such as properties of the surface material, surface roughness, and/or incidence angle of the emitted radar signal beam. In some such examples, the amplitude data 206 is represented as brightness values of a grayscale or false-color images. Higher amplitude values correspond to brighter pixels in the image, indicating stronger radar returns from those areas. Smooth surfaces, such as water bodies tend to reflect less radar energy and appear darker in the image while rough surfaces such as forests, crop fields, or urban areas reflect more radar energy and appear brighter. Thus, the amplitude data 206 includes information about the surface properties of the target geographic area 102.

Further, in some examples, the SAR data processor 204 processes the SAR data 202 to generate interferograms 208. An interferogram 208 is generated by combining two or more SAR data images that are acquired from slightly different satellite positions (e.g., satellite locations 106-110 of a satellite pass or multiple satellite passes) and/or at different times. In some such examples, the process of collecting data and generating interferograms 208 from the data is called Interferometric SAR (InSAR). Interferograms 208 include data describing ground deformation, topographic changes, crop growth changes, and/or other surface displacements.

InSAR enables the described systems and methods to monitor changes on the ground with accuracy down to a centimeter using satellites that are hundreds of kilometers away. Changes such as vertical displacements of objects or other entities on the ground across time can be observed and estimated using changes in phase or polarization in the line-of-sight direction of the satellite as it passes over the associated geographic area.

In some examples, an interferogram 208 is generated by comparing the phase difference between two or more SAR images acquired from different positions and/or from different times (e.g., using coherence data 212). The comparison is performed for each pixel across the overlapping area of the multiple SAR images. The SAR images include interference information caused by the reflection of the emitted radar signal off of the surface of the target geographic area. The interference information is indicative of changes in the phase of the signal due to the distance traveled by the signal and/or due to the properties of the target geographic area surface. In the generated interferograms 208, the phase information at each pixel of the overlapping areas of the multiple SAR images used is compared and differences are demonstrated in the interferograms 208 (e.g., differences represented in fractions and/or quantities of wavelengths). Thus, an interferogram 208 includes data that indicates and/or describes changes to the target geographic area over time and/or based on the location differences between the collecting satellites. By analyzing patterns of interferograms 208, changes such as ground deformation and/or topographic elevation changes can be measured with high precision.

Additionally, or alternatively, in some examples, the generation and/or analysis of the interferograms 208 includes performing phase unwrapping thereon. The differences in phase measured by the interferograms 208 are typically wrapped within a limited range, such as 0 to 2π. This wrapping occurs because the radar signal phase is only measured with respect to module 2π, such that phase changes greater than that “wrap around” to stay within the range. By performing phase unwrapping, potential ambiguities are removed from the interferogram 208 data and true phase values are determined and included in the resulting interferogram 208. The result is data that includes phase changes that are as continuous as possible. In some examples, the system 200 uses the Statistical-cost, Network-flow Algorithm for Phase Unwrapping (SNAPHU). Additionally, or alternatively, in other examples, different algorithms are used without departing from the description (e.g., quality-guided phase unwrapping, path-following algorithms, region-based unwrapping, and/or phase unwrapping using phase differences).

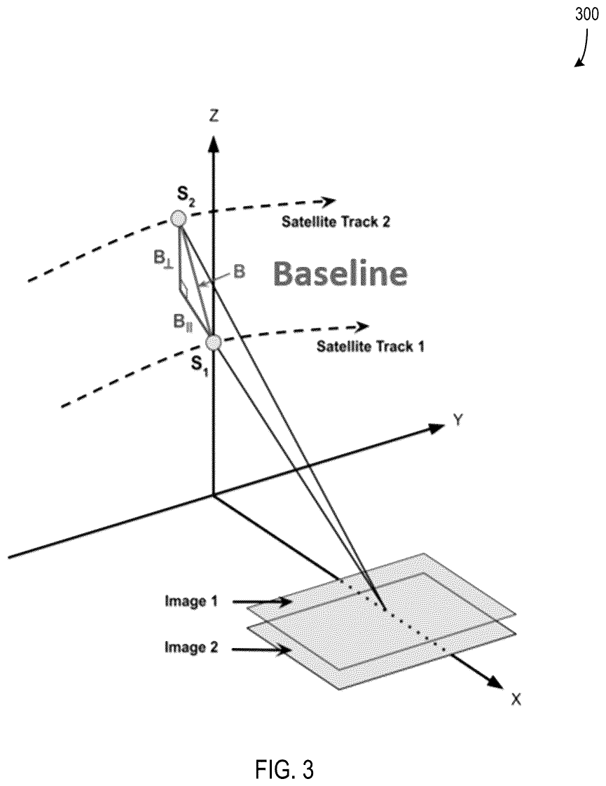

FIG. 3 is a diagram 300 illustrating a comparison of the data collected by a first satellite S₁ and a second satellite S₂. In some examples, the satellites S₁ and S₂ are configured to emit radar signals and capture reflected radar signals as described above with respect to satellite 104 of FIG. 1. As illustrated in FIG. 3, the satellite S₁ travels along a Satellite Track 1 and captures an Image 1 of a target geographic area. Additionally, before or after satellite 1 travels along the Satellite Track 1, the satellite S₂ travels along a Satellite Track 2 that is close to but not the same as Satellite Track 1. The satellite S₂ captures an Image 2 of a target geographic area, wherein Image 1 and Image 2 at least partially overlap on the same geographic area portion. The distance between the satellite S₂ on Satellite Track 1 when it is capturing the Image 1 and satellite S₂ on Satellite Track 2 when it is capturing the Image 2 is defined as the “Baseline” value with respect to the pair of Images 1 and 2. In some examples, the pair of Images 1 and 2 is processed and/or analyzed (e.g., an interferogram 208 is generated from the image pair) and thereby used to estimate the growth of crops in the geographic area targeted by the satellites S₁ and S₂. Alternatively, in some examples, the satellites S₁ and S₂ represent different passes by the same satellite without departing from the description.

In some examples, in order to generate interferogram data that is sufficiently accurate and/or precise, the positions of the two satellites of which images are being compared are within 100 meters of each other at the time of image data collection (e.g., the baseline between the two satellites is within 100 meters). Further, in some such examples, the specific positions of those satellites are known to an accuracy within one centimeter. These requirements and factors of the satellite data collection process provide data that is sufficiently accurate to estimate the growth of crops in observed fields. However, it should be understood that, in other examples, other requirements are defined to obtain different levels of data accuracy without departing from the description.

Additionally, or alternatively, in some examples, the data collected by satellites is only combined to form interferograms if the two or more sets of data are collected within defined time periods of each other. For instance, in an example, two sets of collected image data are only used to generate an interferogram when they are collected within 50 days of each other. With respect to crop growth estimation, using two data sets that are separated by too much time results in data that is difficult or impossible to interpret accurately due, at least in part, to the quantity of growth that the crops may have undergone in the time between satellite passes.

Returning to FIG. 2, in some examples, the SAR data processor 204 processes the SAR data 202 to generate polarimetric data 210. Polarimetric SAR, or PolSAR enables the satellites to transmit and receive signals in multiple polarization states and, through the observation of those states and/or changes to those states between the emitted signal and the reflected signal, additional information can be determined about the state of the target geographic area. The different polarization states include horizontal-horizontal (HH), vertical-vertical (VV), horizontal-vertical (HV), and vertical-horizontal (VH). By analyzing the reflected signals of differently polarized signals, PolSAR is used to classify terrain or land cover (e.g., forests, urban areas, water bodies). In some such examples, man-made structures have unique scattering signatures in different polarization states, so PolSAR can be used to identify those structures. Further, PolSAR provides information regarding the structure and biomass of vegetation in the target geographic area (e.g., detecting the amount of water moisture in soil, measuring canopy volume for forests), lending additional information to the purpose of generating crop growth predictions overtime. Additionally, or alternatively, in some examples, PolSAR enables the measurement of crop growth at larger scales than with interferometry (e.g., larger changes than the wavelength limitations associated with interferometry).

In some examples, Polarimetric interferometric SAR (PolInSAR) is used. PolInSAR is InSAR, as described above, that makes use of different polarity configurations as with PolSAR. Thus, InSAR data is collected using polarized signals in VV states (this is the standard state for InSAR), VH states, and/or HH states. Interferometric data collected for each of these states may differ for a particular geographic area and those differences can be used to determine features of that geographic area.

For instance, in some examples, PolSAR data and/or PolInSAR data is collected and changes in the polarization of the reflected signal are observed. These changes are due to the optical rotation or polarization rotation phenomenon when the polarized signal passes through plant matter on the surface that has chiral molecules therein, or due to scattering when the signal passes through plant matter and/or bounces off the ground or other surface. In some such examples, the described system 200 is configured to collect and record data associated with the polarization changes as part of the PolSAR and/or PolInSAR data. The recorded data is then provided to the crop growth estimation model 218 as input data as described herein. It should be understood that the degree to which polarization of the reflected signals changes when passing through the crops in the geographic area can be used to measure mass, coverage area, or other features of those crops. Thus, the crop growth estimation model 218 can be trained and/or tuned to use such data in the generation of the crop growth prediction 220.

Further, in some examples, coherence data 212 is used to generate the interferograms 208 and for further processing. Coherence is a measure of how well the phases of signals represented in the interferograms 208 are correlated over time and space. High coherence between signals allows for sharp interference fringes in the interferograms 208 and precise measurements of phase differences, while low coherence results in blurred or washed-out interference patterns that are imprecise in many instances. Thus, in some examples, the system 200 uses coherence between pairs of data sets to determine which pairs provide accurate and/or precise data for use by the crop growth estimation model 218.

In some examples, SBAS weights 214 are calculated or otherwise determined using coherence data 212 and the interferograms 208 and those SBAS weights 214 are applied to the interferograms 208 to obtain the weighted interferogram data 216. The SBAS weight 214 for a pair of SAR datasets that form an interferogram 208 is relatively small when the collection of the pair of datasets occurred with large time difference and/or from significantly different positions. Alternatively, a SBAS weight 214 is relatively large when the collection of the pair of datasets occurred within a short time interval and/or from significantly similar positions. Thus, the SBAS weights 214 provide information about the degree to which the associated interferogram 208 is accurate and/or precise. Such SBAS weights 214 are estimated or otherwise generated for each observed satellite pass pair for which a coherence value is determined based on the baseline and time difference between the satellite passes of the satellite pass pair.

The Small Baseline Subset (SBAS) algorithm generates surface deformation time-series from large sequences of SAR data acquired over the same region on earth using differential SAR interferometry. The unwrapped interferometric pairs are corrected to consider topography and combined using regression where each unwrapped interferogram is weighted (e.g., SBAS weights 214) according to surface topography, the baseline, time difference and the coherence data 212. This algorithm is necessary to make the interferograms from the somewhat arbitrary date pairs into sequential pairs corresponding to subsequent satellite passes that describes a time series. Similarly, to make use of the coherence data that is calculated for date pairs according to time and baseline difference, the coherence data must be converted into a time series as well. This is achieved using a new “coherence SBAS” algorithm as described below. For the coherence SBAS algorithm, there is a weighting of the coherence pairs, but the weighting is based only on the baseline and time difference. It should be understood that, in some examples, the SBAS weights 214 of the SAR data processor 204 are determined using the described coherence SBAS algorithm.

In some examples, coherence between two signals (e.g., zero-mean complex signals) is defined by the equation 1 below, wherein Δt₁t₂ is the coherence between signals zₜ_{₁} and zₜ_{₂}. In equation 1, t₁ and t₂ represent the pair of satellite observations associated with the two signals (e.g., the time and position at which each satellite collected each signal z). E is the expected value.

$${Δ}_{{t}_{1} {t}_{2}} = \frac{E [ {z}_{{t}_{1}} {z}_{{t}_{2}}^{*} ]}{\sqrt{E [ {\vert {z}_{{t}_{1}} \vert}^{2} ] E [ {\vert {z}_{{t}_{2}} \vert}^{2} ]}} \qquad ( 1 )$$

The expected coherence for a pixel is estimated as δ from L sample observations within the region of the pixel as follows in equation 2.

$$δ = \frac{{\sum }_{i = 1}^{L} {z}_{{t}_{1} i} {z}_{{t}_{2}}^{*}}{\sqrt{{\sum }_{i = 1}^{L} [ {\vert {z}_{{t}_{1} i} \vert}^{2} ] {\sum }_{i = 1}^{L} [ {\vert {z}_{{t}_{2} i} \vert}^{2} ]}} \qquad ( 2 )$$

In some such examples, the coherence for all consecutive time pairs of collected datasets are used for the described crop growth analysis. This coherence data is extracted or otherwise estimated for all sequential observations by assuming that coherence is multiplicative. In such examples, the coherence Δt₁t₂ of a dataset pair becomes zero as the differences between t₁ and t₂ approach infinity since the observations become independent from one another. Note that 0≤|Δ|≤1. Additionally, it is assumed that the coherence of a pair of observations t₁ and t₃, which are not a consecutive time pair but are separated by an observation t₂ is approximately equal to the coherence of the pair of t₁ and t₂ multiplied by the coherence of the pair t₂ and t₃, or |Δₜ_{₁}ₜ_{₃}|≈|Aₜ_{₁}ₜ_{₂}|Δₜ_{₁}ₜ_{₃}|. Further, vₜ_{₁}ₜ_{₂} is defined as vₜ_{₁}ₜ_{₂}=log|Δvₜ_{₁}ₜ_{₂}, resulting in equation 3 below.

$${v}_{{t}_{1} {t}_{3}} \approx {v}_{{t}_{1} {t}_{2}} + {v}_{{t}_{2} {t}_{3}} \qquad ( 3 )$$

Based on equation 3, the function v for a pair of observations (tᵢ,tⱼ) is represented by equation 4 below.

$${v}_{{t}_{i} {t}_{j}} \approx {v}_{{t}_{i} {t}_{i + 1}} + {v}_{{t}_{i + 1} {t}_{i + 2}} + ⋯ + {v}_{{t}_{j - 1} {t}_{j}} \qquad ( 4 )$$

Because certain pairs i,j are observed, the matrix of equation 5 is formed, wherein ones are placed in the intervals from i to j−1 for each pair i,j.

$$A = ( \begin{matrix}1 & 1 & ⋯ & 1 & 0 & ⋯ & 0 & 0 \\ ⋮ & ⋮ & ⋱ & ⋮ & ⋮ & ⋱ & ⋮ & ⋮ \\ 0 & 0 & ⋯ & 0 & 0 & ⋯ & 1 & 1\end{matrix} ) \qquad ( 5 )$$

With the defined matrix A, the relationship illustrated in equation 6 results, wherein o are the observed coherence pair, m is the number of observed coherence pairs, and n is the number of passes by the satellite(s).

$$Av = A ( \begin{matrix}{v}_{{t}_{1} {t}_{2}} \\ {v}_{{t}_{2} {t}_{3}} \\ ⋮ \\ {v}_{{t}_{n - 1} {t}_{n}}\end{matrix} ) \approx ( \begin{matrix}{v}_{{t}_{{i}_{1}} {t}_{{j}_{1}}} \\ {v}_{{t}_{{i}_{2}} {t}_{{j}_{2}}} \\ ⋮ \\ {v}_{{t}_{{i}_{m}} {t}_{{j}_{m}}}\end{matrix} ) {=}^{def} o \qquad ( 6 )$$

To estimate coherence values for unobserved coherence pairs, the least square solution for the matrix of equation 6 is calculated. SBAS weights 214 are then calculated or otherwise determined for each equation of the matrix to reflect that coherence pairs that are far apart in time and/or have large baselines are inherently noisier and/or less precise. Weights of pairs with larger baselines and/or temporal gaps are smaller, while weights of pairs with smaller baseline and/or temporal gaps are larger. The weights are denoted as w in equation 7 below.

$$w ∘ Av \approx w ∘ o \qquad ( 7 )$$

A matrix of weights W=diag(w), resulting in the equation 8 below.

$$WAv \approx Wo \qquad ( 8 )$$

An objective loss function as shown in equation 9 is derived from equation 8.

$$f ( 0 ) = {‖ WAv - Wo ‖}^{2} \qquad ( 9 )$$

This function is a standard regression loss, and the solution is found by setting the derivative to zero. The derivative is shown in equation 10.

$$\frac{\partial f}{\partial 0} = - 2 W ( WAv - Wo ) \qquad ( 10 )$$

The root to equation 10 is shown in equation 11.

$$0 = {( {A}^{T} {W}^{2} A )}^{- 1} {A}^{T} {W}^{2} v \qquad ( 11 )$$

Using these equations, the SBAS weights 214 are determined for each coherence pair of the interferograms 208. The SBAS weights 214 are applied to the associated interferograms 208 to form weighted interferogram data 216, which is provided to the crop growth estimation model 218 as input. In some such examples, the model 218 is configured and trained to generate a crop growth prediction 220 based on the weighted interferogram data 216 as described herein.

In some examples, the crop growth estimation model 218 is a convolutional neural network (CNN), or other neural network model (such as a U-Net, Neural Attention model, or Transformer), that is trained to generate crop growth prediction 220. In some examples, the model 218 includes a series of convolutional layers consisting of filters that slide or convolve across the input data, performing a series of element-wise multiplications and/or summations to produce feature maps. In some such examples, the filters are configured to capture spatial patterns and/or features from the input data. The output of a convolutional layer is a set of feature maps that represent the presence of learned features in different regions of the input. For instance, in an example where the model 218 is trained to generate the crop growth prediction 220, the convolutional layer filters of the model 218 are configured to identify crop height or growth features.

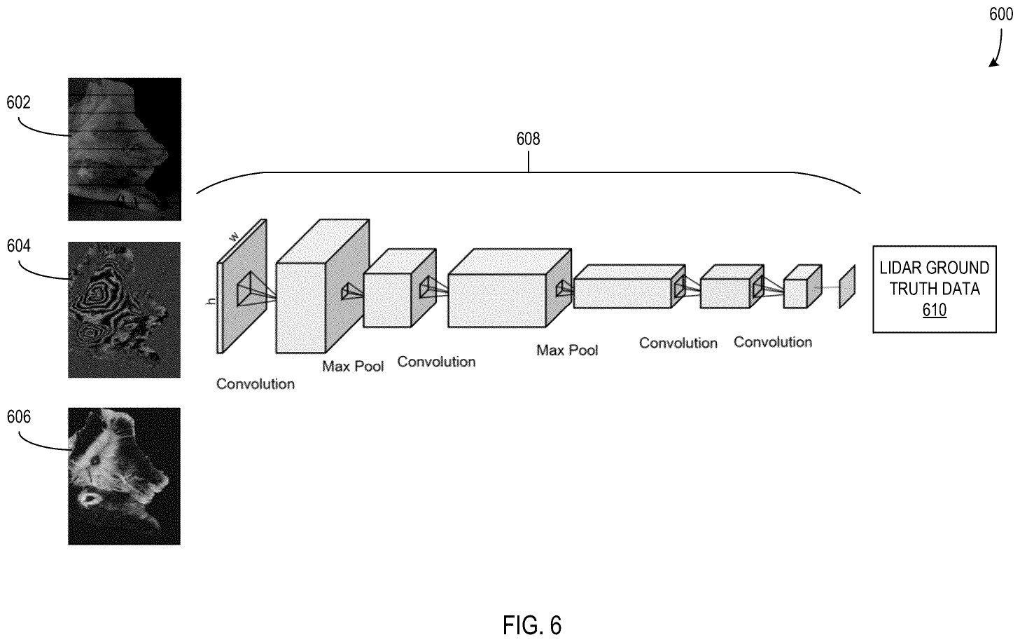

Further, in some examples, the training of the crop growth estimation model 218 includes the collection of ground truth data from geographic areas (e.g., drones are flown over crop fields and crop height is measured precisely using Light Detection and Ranging (LIDAR)). An example of the crop growth estimation model 218 is illustrated in FIG. 6. Processed SAR data from the SAR data processor 204 associated with the geographic areas for which ground truth data has been collected is provided to the crop growth estimation model 218 as input data and the crop growth estimation model 218 generates crop growth prediction 220 based thereon. The generated crop growth prediction 220 is compared to the ground truth data and, based on the differences between the generated crop growth prediction 220 and the ground truth data, weights, parameters, and/or other features of the crop growth estimation model 218 are adjusted. The adjustments made to the model 218 result in the differences between the generated crop growth prediction 220 and the ground truth data being reduced, or, in other words, a loss function of the crop growth estimation model 218 is reduced or minimized.

Additionally, or alternatively, in some examples, the crop growth estimation model 218 is configured to include other CNN features such as activation functions for introducing non-linearities into the network, pooling layers for down-sampling the feature maps produced by the convolutional layers, fully connected layers for performing classification or regression tasks on the produced feature maps, and/or regularization techniques used to prevent overfitting and/or improve generalization.

It should be understood that, in other examples, other types of neural network architectures or machine learning models are used for the crop growth estimation model 218 without departing from the description.

In some examples, to ameliorate issues with observed data, the crop growth estimation model 218 and/or the system 200 in general is configured to estimate the parameters of a sigmoidal growth curve instead of direct crop growth estimation. By estimating such a curve for a group of crops, the system 200 is enabled to make continuous estimations throughout a time period despite issues with the collected data, such as a lack of quality observed data for portions of the time period. In some such examples, a crop model based on the growing degree days (GDD) is used in place of time as well. This method requires the estimation of only three parameters (time, growth rate, and peak height) for each given pixel in a time series, thereby alleviating the complexity of some other estimation methods. Other crop process-based models of plant growth can be used if controlled by very few parameters.

Further, in some examples, VH polarization is used as a complement to VV polarization. Coherence, estimated Line of Sight (LOS) displacement using SBAS and unwrapped interferograms, and SAR magnitude are collected and analyzed for both VV and VH polarizations. Additionally, multiple radar bands are used by the satellites to collect a variety of data associated with different frequencies and/or wavelengths of radar signals. Combining all these information sources as input for the crop growth estimation model 218 enables the system 200 to better improve the accuracy and/or precision of the generated crop growth prediction 220.

It should be understood that, in some examples, the SAR data 202 includes data collected using radar signals with a wide range of different frequencies and wavelengths. The use of varied frequency radar signals is used with InSAR as well as with PolSAR and PolInSAR to generate additional, corroborating data points during the data collection process. The effects of the crops and other objects or entities in the target geographic area on radar signals may differ based on the frequency of the radar signals, such that additional information can be obtained about the crops and other objects or entities by using a variety of frequencies during data collection. For instance, in examples where the polarization rotation effect is captured in the SAR data 202, the degree of that effect changes based on the frequency of the signal, such that the use of signals of multiple frequencies provides multiple data points and enables greater estimations and/or predictions to be made about the mass or quantity of biological material in the target geographic area. In some such examples, data from many different radar frequency bands enables the measurement and/or determination of quantities of chlorophyll, sugar, and/or other substances in the observed crops.

In some examples, the crop growth prediction 220 includes a plurality of values associated with a target geographic area, wherein each of the plurality of values indicates an amount that crops are estimated to have grown in a portion of the target geographic area over the course of a defined time period. Such data values can be provided in the form of a list of values, a matrix or grid of values, or another type of visualization, such as a heatmap where the colors of the pixels indicate a range of estimated crop growth within the associated geographic area portion. Further, in some examples, the crop growth prediction 220 includes an overall growth data value associated with the target geographic area, such as an average estimated growth value or the like. The described systems and methods enable the generation of highly granular crop growth estimation through the detection of crop growth at cm level precision for each small portion of the target geographic area.

Further, in some examples, the SAR data processor 204 is configured to perform other processes on the SAR data 202 to account for other challenges to the described process. For instance, in some examples, features of the observed geographic area and the atmosphere between the area and the satellites results in noise being introduced to the emitted and reflected signals. Charged particles in the ionosphere, temperature, water vapor, and/or pressure can all introduce noise into the signals. In such examples, the SAR data processor 204 is configured to use known stations, buildings, or other structures to provide ground truth data that is then used to control for introduced noise. Global Navigation Satellite System (GNSS) stations are used as ground truth data for specific locations to correct for noise and error in the signals because the positions and altitudes of such stations are known with high accuracy.

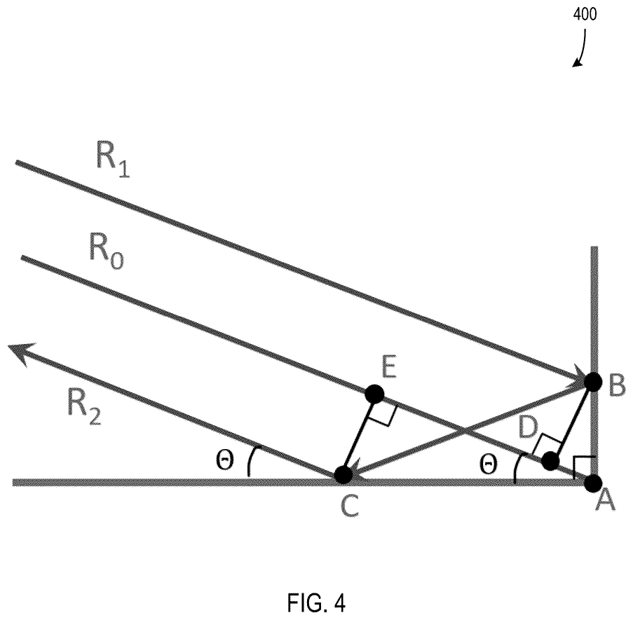

Additionally, or alternatively, in areas where GNSS stations are not present, other structures are used as ground truth reflectors by the satellites and SAR data processor 204. For instance, in some examples, reflector structures such as corner reflectors are deployed near target crop fields. In other examples, existing buildings, such as houses, barns, or silos, can be used as reflectors that provide ground truth data. An example of how such signal reflections provide ground truth data is illustrated in FIG. 4.

FIG. 4 is a diagram illustrating the geometry of the reflection of signals off of the vertical wall of a structure, such as a silo or other farm building. As shown, an emitted signal R₁ that reflects off of the vertical wall at B, the ground at C and reflects a signal R₂ back to the emitting satellite is equivalent to a signal R₀ that reflects off the base of the wall at A. This can be described using the following proof that R₁+BC+R₂=2R₀, wherein BC is the length from point B to point C.

R₀=R₁+AD=R₂+AE, wherein AD is the length between points A and D and AE is the length between points A and E.

Because ΔABC (the angle at B between the lines to A and C) and ΔACE (the angle at C between the lines to A and E) are similar,

$$\frac{A E}{A C} = \frac{A C}{B C} ,$$

wherein AC is the length between points A and C and BC is the length between points B and C.

Because ΔABC (the angle at B between the lines to A and C) and ΔABD (the angle at B between the lines to A and D) are similar,

$$\frac{A E}{A C} = \frac{A C}{B C} ,$$

wherein AB is the length between points A and B.

Therefore, the following equation 12 is true.

$$A E + A D = \frac{{( A C )}^{2} + {( A B )}^{2}}{B C} = \frac{{( B C )}^{2}}{B C} = B C \qquad ( 12 )$$

Thus, the length of the double bounce of R₁ to R₂ is described in the following equation 13.

$${R}_{1} + B C + {R}_{2} = {R}_{1} + A E + A D + {R}_{2} = {R}_{0} + {R}_{0} = 2 {R}_{0} \qquad ( 13 )$$

Because the reflection of the emitted signal R₁ is equivalent to the signal R₁ reflecting off the base on the wall at A, the data signal R₂ captured by the satellite appears to be reflected from the same distance as the point A. Thus, the structure provides a bright spot in the resulting image at or near the location and altitude of the point A, providing a ground truth that the system 200 uses to control for noise and/or error.

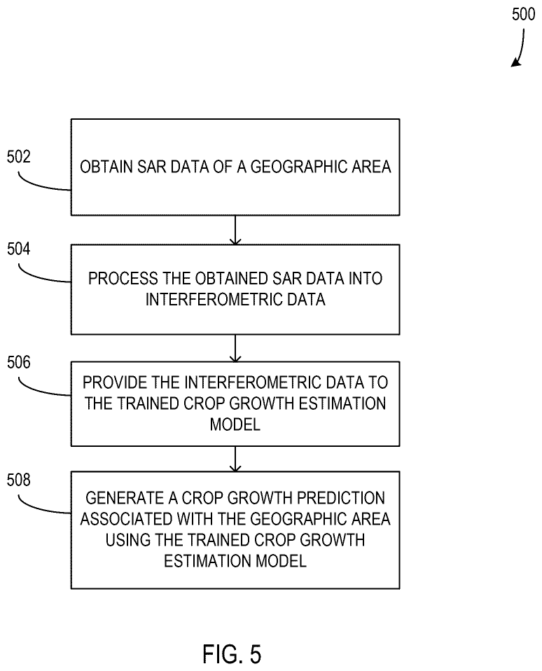

FIG. 5 is a flowchart illustrating an example method 500 for generating a crop growth prediction using SAR data. In some examples, the method 500 is executed or otherwise performed in a system such as systems 100 and 200 of FIGS. 1 and 2, respectively.

At 502, SAR data is obtained of a geographic area. In some examples, the SAR data is obtained by one or more satellites passing in range of the geographic area, emitting radar signals at the geographic area, and capturing reflected signals of those radar signals from the surface and/or objects that are in the geographic area. Further, in some examples, a satellite collects data from the geographic area in multiple satellite passes over time and/or multiple satellites collect data from the geographic area in multiple satellite passes over time. Additionally, in some examples, the satellites use one or more types of SAR, such as polarimetric interferometric SAR (PolInSAR) to obtain the SAR data of the geographic area.

At 504, the obtained SAR data is processed into interferometric data. In some examples, generating the interferometric data from the obtained SAR data includes analyzing the SAR data from two or more different satellite passes together and identifying the differences therebetween. The interferometric data, often represented in an interferogram, displays or otherwise provides information about how the phase of the obtained SAR data has changed from the data of one satellite pass to the data of another satellite pass, which can be indicative of the growth of crops in the geographic area.

Further, in some examples, coherence values for pairs of SAR data subsets associated with different satellite passes are calculated. The coherence values provide an indication as to how well the phases of two SAR data subsets are correlated over time and space. The coherence values are used to generate weights for the SAR data subset pairs (e.g., SBAS weights) that are then applied to the interferometric data associated with those SAR data subset pairs. These weights enable the crop growth estimation model to weigh the interferometric data of some SAR data subset pairs more heavily than the interferometric data of other SAR data subset pairs, wherein SAR data subset pairs for which the data was collected in relatively close spatial and/or temporal proximity are weighted more heavily than SAR data subset pairs for which the data was collected with larger spatial and/or temporal gaps between the satellite passes.

Additionally, or alternatively, in some examples, processing the obtained SAR data into the interferometric data includes applying a phase unwrapping algorithm to the interferometric data. For instance, in an example, the obtained SAR data is first converted into interferometric data and then a phase unwrapping algorithm is applied to that interferometric data to form unwrapped interferometric data. In some such examples, the coherence data is used during the application of the phase unwrapping algorithm. The unwrapped interferogram is then used throughout the rest of the method 500 as described herein.

In some examples, the method at 504 includes generating otherwise obtaining interferograms and associated coherence images. The interferograms are then processed into unwrapped interferograms and then, the resulting unwrapped interferograms are processed into a displacement time series using SBAS. Further, in some such examples, amplitude SAR data is used for analysis of VV polarization and/or VH polarization of those signals as well.

At 506, the interferometric data is provided to the trained crop growth estimation model. In some examples, the SAR data is processed into additional or other processed SAR data, such as amplitude data, coherence time series data, and/or PolInSAR data, which is also provided to the trained crop growth estimation model as input.

Further, in some examples, the obtained SAR data includes reflected signal data from reflector structures positioned on the ground in the geographic area. These reflector structures provide ground truth data that is used to account for noise and/or errors in the signals when processing the obtained SAR data into interferometric data and/or other processed SAR data. In some such examples, the reflector structures include GNSS stations, corner reflectors, or buildings or other structures with vertical walls that meet the ground surface of the geographic area. Much of the noise in the described data stems from errors in the digital elevation model and from atmospheric noise (magnetic and electrical disturbances). Atmospheric noise changes slowly across space so a correction found for a particular location is valid for a large surrounding area. A single radar reflector or building reflector can be used to reliably correct atmospheric noise for any point within a radius of 10 kilometers or greater (assuming no seismic activity).

At 508, a crop growth prediction associated with the geographic area is generated using the trained crop growth estimation model. In some examples, the crop growth prediction includes growth estimate values for each portion of the geographic area and those growth estimate values are displayed or otherwise provided in a pixel-based heat map visualization. Alternatively, or additionally, the crop growth estimation model is trained to generate estimated parameters of sigmoidal growth curves associated with the crops growing in the geographic area, such that the crop growth prediction includes those estimated parameters.

Additionally, in some examples, the method 500 further includes obtaining ground truth data associated with the height of the crops in the geographic area at various times. For instance, in some examples, the ground truth data is collected by drones or other devices using LIDAR. In some such examples, the ground truth data is compared to the crop growth prediction generated by the crop growth estimation model and, based on differences between the two data sets, the parameters and/or other aspects of the crop growth estimation model are adjusted using neural network techniques, such that the adjusted model is more likely to generate a crop growth prediction that is closer to the ground truth data during future iterations. In some examples, the crop growth estimation model is a CNN, but in other examples, the model is another type of neural network model without departing from the description.

It should be understood that, while the description herein is primarily directed to measuring and/or predicting crop growth using the described systems and methods, in other examples, these systems and methods are used to measure and/or predict other things. For instance, in some examples, the described systems and methods are used to monitor and/or predict the growth of forests and/or other environmental areas (e.g., coastline erosion monitoring) for use in research and/or conservation efforts. Additionally, or alternatively, in some examples, the described systems and methods are used to monitor and/or predict the growth and/or change of urban landscapes. In such examples, instead of crop growth estimation and prediction, the systems and methods perform feature change estimation and prediction tasks associated with measurable features of the geographic area being monitored (e.g., the height of trees in a forest, the shape of a coastline, and/or the height and shape of building in an urban landscape).

FIG. 6 is a diagram illustrating a structure of an example Convolutional Neural Network (CNN) for operation as a feature change estimation model (e.g., crop growth estimation model 218). In some examples, the input data to the illustrated CNN includes at least one of an amplitude image 602, an interferogram 604, and/or a coherence image 606. The input data is then processed by a series of layers 608, including convolution layers and max pool layers. Throughout the processing performed by the layers 608, features in the input images are identified and those features are used to generate crop growth predictions and/or other feature change predictions as described herein. It should be understood that, in other examples, CNNs with different structures are used without departing from the description.

Further, in some examples, LIDAR ground truth data 610 (e.g., the current height of crops in the target fields) is collected from the target geographic area over time and the output of the CNN layers 608 is compared to the LIDAR ground truth data 610. Based on the comparison, parameters and/or other features of the layers 608 are adjusted to train or tune the layers 608 to generate more accurate output in the future. Thus, the layers 608 are trained to predict the data, such as the current crop height, that would be collected using a LIDAR drone at a particular point in time based on the inputs 6021, 604, and 606.

### Exemplary Operating Environment

The present disclosure is operable with a computing apparatus according to an embodiment as a functional block diagram 700 in FIG. 7. In an example, components of a computing apparatus 718 are implemented as a part of an electronic device according to one or more embodiments described in this specification. The computing apparatus 718 comprises one or more processors 719 which may be microprocessors, controllers, or any other suitable type of processors for processing computer executable instructions to control the operation of the electronic device. Alternatively, or in addition, the processor 719 is any technology capable of executing logic or instructions, such as a hard-coded machine. In some examples, platform software comprising an operating system 720 or any other suitable platform software is provided on the apparatus 718 to enable application software 721 to be executed on the device. In some examples, generating a crop growth estimate using satellite-collected radar data as described herein is accomplished by software, hardware, and/or firmware.

In some examples, computer executable instructions are provided using any computer-readable media that is accessible by the computing apparatus 718. Computer-readable media include, for example, computer storage media such as a memory 722 and communications media. Computer storage media, such as a memory 722, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 722) is shown within the computing apparatus 718, it will be appreciated by a person skilled in the art, that, in some examples, the storage is distributed or located remotely and accessed via a network or other communication link (e.g., using a communication interface 723).

Further, in some examples, the computing apparatus 718 comprises an input/output controller 724 configured to output information to one or more output devices 725, for example a display or a speaker, which are separate from or integral to the electronic device. Additionally, or alternatively, the input/output controller 724 is configured to receive and process an input from one or more input devices 726, for example, a keyboard, a microphone, or a touchpad. In one example, the output device 725 also acts as the input device. An example of such a device is a touch sensitive display. The input/output controller 724 may also output data to devices other than the output device, e.g., a locally connected printing device. In some examples, a user provides input to the input device(s) 726 and/or receives output from the output device(s) 725.

The functionality described herein can be performed, at least in part, by one or more hardware logic components. According to an embodiment, the computing apparatus 718 is configured by the program code when executed by the processor 719 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises a processor; and a memory comprising computer program code, the memory and the computer program code configured to cause the processor to: obtain synthetic aperture radar (SAR) data of a geographic area from a plurality of satellite passes by a satellite; calculate a coherence value for a SAR data subset pair including a first SAR data subset and a second SAR data subset, wherein the first SAR data subset is associated with a first satellite pass of the plurality of satellite passes and the second SAR data subset is associated with a second satellite pass of the plurality of satellite passes; process the obtained SAR data into interferometric data using the calculated coherence value; provide the coherence value and the interferometric data to a trained crop growth estimation model; and generate, using the trained crop growth estimation model, a crop growth prediction associated with the geographic area.

An example computerized method comprises obtaining synthetic aperture radar (SAR) data of a geographic area from a plurality of satellite passes by a satellite; calculating a coherence value for a SAR data subset pair including a first SAR data subset and a second SAR data subset, wherein the first SAR data subset is associated with a first satellite pass of the plurality of satellite passes and the second SAR data subset is associated with a second satellite pass of the plurality of satellite passes; processing the obtained SAR data into interferometric data using the calculated coherence value; generating a small baseline subset (SBAS) weight based on a baseline distance between the first satellite pass and the second satellite pass and a time difference between the first satellite pass and the second satellite pass; weighting the coherence value using the generated SBAS weight value; providing the weighted coherence value and the interferometric data to a trained feature change estimation model; and generating, using the trained feature change estimation model, a feature change prediction associated with the geographic area.

One or more computer storage media have computer-executable instructions that, upon execution by a processor, cause the processor to at least obtain synthetic aperture radar (SAR) data of a geographic area from a plurality of satellite passes by a satellite, the obtained SAR data including amplitude data and polarimetric SAR data; calculate a coherence value for a SAR data subset pair including a first SAR data subset and a second SAR data subset, wherein the first SAR data subset is associated with a first satellite pass of the plurality of satellite passes and the second SAR data subset is associated with a second satellite pass of the plurality of satellite passes; process the obtained SAR data into interferometric data using the calculated coherence value; provide the amplitude data, the polarimetric SAR data, the coherence value, and the interferometric data to a trained crop growth estimation model; and generate, using the trained crop growth estimation model, a crop growth prediction associated with the geographic area.

Alternatively, or in addition to the other examples described herein, examples include any combination of the following:
wherein calculating the coherence value for the SAR data subset pair includes: generating a small baseline subset (SBAS) weight value based on a baseline distance between the first satellite pass and the second satellite pass and a time difference between the first satellite pass and the second satellite pass; and weighting the coherence value using the generated SBAS weight value, wherein the weighted coherence value is provided to the trained crop growth estimation model.
wherein calculating the coherence value for the SAR data subset pair including the first SAR data subset and the second SAR data subset further includes: determining a plurality of observed SAR data subset pairs included in the obtained SAR data; calculating observed coherence values for the observed SAR data subset pairs; determining a plurality of unobserved SAR data sequential pairs based on a time interval length of the obtained SAR data and the observed SAR data subset pairs; defining a matrix with entries for each sequential SAR data subset pair, wherein observed SAR data subset pairs are represented by ones and unobserved SAR data subset pairs are represented by zeros; and calculating estimated coherence values for the unobserved SAR data subset pairs by finding a least square solution of a matrix equation using the defined matrix and logarithmic values determined from the calculated observed coherence values for the observed SAR data subset pairs, wherein the calculated observed coherence values and calculated estimated coherence values are provided to the trained crop growth estimation model.
wherein the memory and the computer program code are configured to further cause the processor to: process the obtained SAR data into additional processed SAR data, wherein the additional processed SAR data includes at least one of the following: amplitude data or polarimetric SAR data; and wherein the additional processed SAR data is provided to the trained crop growth estimation model.
wherein the obtained SAR data includes reflected signal data from a reflector structure positioned on a ground surface of the geographic area, wherein the reflector structure includes at least one of a global navigation satellite system (GNSS) station, a corner reflector structure, or a structure with a vertical wall; and wherein processing the obtained SAR data into the additional processed SAR data includes reducing noise in the additional processed SAR data using the reflected signal data from the reflector structure.
wherein the memory and the computer program code are configured to further cause the processor to: obtain ground truth data of the geographic area using light detection and ranging (LIDAR); and adjust the trained crop growth estimation model based on a comparison of the obtained ground truth data to the generated crop growth prediction.
wherein processing the obtained SAR data into the interferometric data includes: converting the obtained SAR data into the interferometric data; and applying a phase unwrapping algorithm to the interferometric data, wherein the phase unwrapped interferometric is provided to the trained crop growth estimation model.
wherein the generated crop growth prediction includes estimated parameters of a sigmoidal growth curve associated with crops growing in the geographic area.
wherein the obtained SAR data includes polarimetric SAR (PolSAR) data associated with at least one of VV polarization, VH polarization, HH polarization, and HV polarization; wherein the PolSAR data includes polarization rotation data indicating a polarization rotation effect associated with plant matter in the geographic area; wherein the polarization rotation data is provided to the trained crop growth estimation model; and wherein the trained crop growth estimation model generates the crop growth prediction based at least in part on the polarization rotation data.
wherein the obtained SAR data includes first frequency data associated with a first radar frequency and second frequency data associated with a second radar frequency; wherein the first frequency data and the second frequency data are provided to the trained crop growth estimation model; and wherein the trained crop growth estimation model generates the crop growth prediction based at least in part on the first frequency data and the second frequency data.
wherein calculating the coherence value for the SAR data subset pair including the first SAR data subset and the second SAR data subset further includes: determining a plurality of observed SAR data subset pairs included in the obtained SAR data; calculating observed coherence values for the observed SAR data subset pairs;
determining a plurality of unobserved SAR data sequential pairs based on a time interval length of the obtained SAR data and the observed SAR data subset pairs; defining a matrix with entries for each sequential SAR data subset pair, wherein observed SAR data subset pairs are represented by ones and unobserved SAR data subset pairs are represented by zeros; and calculating estimated coherence values for the unobserved SAR data subset pairs by finding a least square solution of a matrix equation using the defined matrix and logarithmic values determined from the calculated observed coherence values for the observed SAR data subset pairs, wherein the calculated observed coherence values and calculated estimated coherence values are provided to the trained feature change estimation model.
further comprising: processing the obtained SAR data into additional processed SAR data, wherein the additional processed SAR data includes at least one of the following: amplitude data or polarimetric SAR data; and wherein the additional processed SAR data is provided to the trained feature change estimation model.
wherein the obtained SAR data includes reflected signal data from a reflector structure positioned on a ground surface of the geographic area, wherein the reflector structure includes at least one of a global navigation satellite system (GNSS) station, a corner reflector structure, or a structure with a vertical wall; and wherein processing the obtained SAR data into the additional processed SAR data includes reducing noise in the additional processed SAR data using the reflected signal data from the reflector structure.
further comprising: obtaining ground truth data of the geographic area using light detection and ranging (LIDAR); and adjusting the trained feature change estimation model based on a comparison of the obtained ground truth data to the generated feature change prediction.
wherein processing the obtained SAR data into the interferometric data includes: converting the obtained SAR data into the interferometric data; and applying a phase unwrapping algorithm to the interferometric data, wherein the phase unwrapped interferometric is provided to the trained feature change estimation model.
wherein the generated feature change prediction includes estimated parameters of a geographic feature model for change estimation associated with features in the geographic area.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for obtaining synthetic aperture radar (SAR) data of a geographic area from a plurality of satellite passes by a satellite; exemplary means for calculating a coherence value for a SAR data subset pair including a first SAR data subset and a second SAR data subset, wherein the first SAR data subset is associated with a first satellite pass of the plurality of satellite passes and the second SAR data subset is associated with a second satellite pass of the plurality of satellite passes; exemplary means for processing the obtained SAR data into interferometric data using the calculated coherence value; exemplary means for generating a small baseline subset (SBAS) weight based on a baseline distance between the first satellite pass and the second satellite pass and a time difference between the first satellite pass and the second satellite pass; exemplary means for weighting the coherence value using the generated SBAS weight value; exemplary means for providing the weighted coherence value and the interferometric data to a trained feature change estimation model; and exemplary means for generating, using the trained feature change estimation model, a feature change prediction associated with the geographic area.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a memory comprising computer program code, the memory and the computer program code configured to cause the processor to:
obtain synthetic aperture radar (SAR) data of a geographic area from a plurality of satellite passes by a satellite;
calculate a coherence value for a SAR data subset pair including a first SAR data subset and a second SAR data subset, wherein the first SAR data subset is associated with a first satellite pass of the plurality of satellite passes and the second SAR data subset is associated with a second satellite pass of the plurality of satellite passes;
process the obtained SAR data into interferometric data using the calculated coherence value;
provide the coherence value and the interferometric data to a trained crop growth estimation model; and
generate, using the trained crop growth estimation model, a crop growth prediction associated with the geographic area.

2. The system of claim 1, wherein calculating the coherence value for the SAR data subset pair includes:
generating a small baseline subset (SBAS) weight value based on a baseline distance between the first satellite pass and the second satellite pass and a time difference between the first satellite pass and the second satellite pass; and
weighting the coherence value using the generated SBAS weight value, wherein the weighted coherence value is provided to the trained crop growth estimation model.

3. The system of claim 1, wherein calculating the coherence value for the SAR data subset pair including the first SAR data subset and the second SAR data subset further includes:
determining a plurality of observed SAR data subset pairs included in the obtained SAR data;
calculating observed coherence values for the observed SAR data subset pairs;
determining a plurality of unobserved SAR data sequential pairs based on a time interval length of the obtained SAR data and the observed SAR data subset pairs;
defining a matrix with entries for each sequential SAR data subset pair, wherein observed SAR data subset pairs are represented by ones and unobserved SAR data subset pairs are represented by zeros; and
calculating estimated coherence values for the unobserved SAR data subset pairs by finding a least square solution of a matrix equation using the defined matrix and logarithmic values determined from the calculated observed coherence values for the observed SAR data subset pairs, wherein the calculated observed coherence values and calculated estimated coherence values are provided to the trained crop growth estimation model.

4. The system of claim 1, wherein the memory and the computer program code are configured to further cause the processor to:
process the obtained SAR data into additional processed SAR data, wherein the additional processed SAR data includes at least one of the following: amplitude data or polarimetric SAR data; and
wherein the additional processed SAR data is provided to the trained crop growth estimation model.

5. The system of claim 4, wherein the obtained SAR data includes reflected signal data from a reflector structure positioned on a ground surface of the geographic area, wherein the reflector structure includes at least one of a global navigation satellite system (GNSS) station, a corner reflector structure, or a structure with a vertical wall; and
wherein processing the obtained SAR data into the additional processed SAR data includes reducing noise in the additional processed SAR data using the reflected signal data from the reflector structure.

6. The system of claim 1, wherein the memory and the computer program code are configured to further cause the processor to:
obtain ground truth data of the geographic area using light detection and ranging (LIDAR); and
adjust the trained crop growth estimation model based on a comparison of the obtained ground truth data to the generated crop growth prediction.

7. The system of claim 1, wherein processing the obtained SAR data into the interferometric data includes:
converting the obtained SAR data into the interferometric data; and
applying a phase unwrapping algorithm to the interferometric data, wherein the phase unwrapped interferometric is provided to the trained crop growth estimation model.

8. The system of claim 1, wherein the generated crop growth prediction includes estimated parameters of a sigmoidal growth curve associated with crops growing in the geographic area.

9. The system of claim 1, wherein the obtained SAR data includes polarimetric SAR (PolSAR) data associated with at least one of VV polarization, VH polarization, HH polarization, and HV polarization;
wherein the PolSAR data includes polarization rotation data indicating a polarization rotation effect associated with plant matter in the geographic area;
wherein the polarization rotation data is provided to the trained crop growth estimation model; and
wherein the trained crop growth estimation model generates the crop growth prediction based at least in part on the polarization rotation data.

10. The system of claim 1, wherein the obtained SAR data includes first frequency data associated with a first radar frequency and second frequency data associated with a second radar frequency;
wherein the first frequency data and the second frequency data are provided to the trained crop growth estimation model; and
wherein the trained crop growth estimation model generates the crop growth prediction based at least in part on the first frequency data and the second frequency data.

11. A computerized method comprising:
obtaining synthetic aperture radar (SAR) data of a geographic area from a plurality of satellite passes by a satellite;
calculating a coherence value for a SAR data subset pair including a first SAR data subset and a second SAR data subset, wherein the first SAR data subset is associated with a first satellite pass of the plurality of satellite passes and the second SAR data subset is associated with a second satellite pass of the plurality of satellite passes;
processing the obtained SAR data into interferometric data using the calculated coherence value;
generating a small baseline subset (SBAS) weight based on a baseline distance between the first satellite pass and the second satellite pass and a time difference between the first satellite pass and the second satellite pass;
weighting the coherence value using the generated SBAS weight value;
providing the weighted coherence value and the interferometric data to a trained feature change estimation model; and
generating, using the trained feature change estimation model, a feature change prediction associated with the geographic area.

12. The computerized method of claim 11, wherein calculating the coherence value for the SAR data subset pair including the first SAR data subset and the second SAR data subset further includes:
determining a plurality of observed SAR data subset pairs included in the obtained SAR data;
calculating observed coherence values for the observed SAR data subset pairs;
determining a plurality of unobserved SAR data sequential pairs based on a time interval length of the obtained SAR data and the observed SAR data subset pairs;
defining a matrix with entries for each sequential SAR data subset pair, wherein observed SAR data subset pairs are represented by ones and unobserved SAR data subset pairs are represented by zeros; and
calculating estimated coherence values for the unobserved SAR data subset pairs by finding a least square solution of a matrix equation using the defined matrix and logarithmic values determined from the calculated observed coherence values for the observed SAR data subset pairs, wherein the calculated observed coherence values and calculated estimated coherence values are provided to the trained feature change estimation model.

13. The computerized method of claim 11, further comprising:
processing the obtained SAR data into additional processed SAR data, wherein the additional processed SAR data includes at least one of the following: amplitude data or polarimetric SAR data; and
wherein the additional processed SAR data is provided to the trained feature change estimation model.

14. The computerized method of claim 13, wherein the obtained SAR data includes reflected signal data from a reflector structure positioned on a ground surface of the geographic area, wherein the reflector structure includes at least one of a global navigation satellite system (GNSS) station, a corner reflector structure, or a structure with a vertical wall; and
wherein processing the obtained SAR data into the additional processed SAR data includes reducing noise in the additional processed SAR data using the reflected signal data from the reflector structure.

15. The computerized method of claim 11, further comprising:
obtaining ground truth data of the geographic area using light detection and ranging (LIDAR); and
adjusting the trained feature change estimation model based on a comparison of the obtained ground truth data to the generated feature change prediction.

16. The computerized method of claim 11, wherein processing the obtained SAR data into the interferometric data includes:
converting the obtained SAR data into the interferometric data; and
applying a phase unwrapping algorithm to the interferometric data, wherein the phase unwrapped interferometric is provided to the trained feature change estimation model.

17. The computerized method of claim 11, wherein the generated feature change prediction includes estimated parameters of a geographic feature model for change estimation associated with features in the geographic area.

18. A computer storage medium has computer-executable instructions that, upon execution by a processor, cause the processor to at least:
obtain synthetic aperture radar (SAR) data of a geographic area from a plurality of satellite passes by a satellite, the obtained SAR data including amplitude data and polarimetric SAR data;
calculate a coherence value for a SAR data subset pair including a first SAR data subset and a second SAR data subset, wherein the first SAR data subset is associated with a first satellite pass of the plurality of satellite passes and the second SAR data subset is associated with a second satellite pass of the plurality of satellite passes;
process the obtained SAR data into interferometric data using the calculated coherence value;
provide the amplitude data, the polarimetric SAR data, the coherence value, and the interferometric data to a trained crop growth estimation model; and
generate, using the trained crop growth estimation model, a crop growth prediction associated with the geographic area.

19. The computer storage medium of claim 18, wherein calculating the coherence value for the SAR data subset pair includes:
generating a small baseline subset (SBAS) weight value based on a baseline distance between the first satellite pass and the second satellite pass and a time difference between the first satellite pass and the second satellite pass; and
weighting the coherence value using the generated SBAS weight value, wherein the weighted coherence value is provided to the trained crop growth estimation model.

20. The computer storage medium of claim 18, wherein calculating the coherence value for the SAR data subset pair including the first SAR data subset and the second SAR data subset further includes:
determining a plurality of observed SAR data subset pairs included in the obtained SAR data;
calculating observed coherence values for the observed SAR data subset pairs;
determining a plurality of unobserved SAR data sequential pairs based on a time interval length of the obtained SAR data and the observed SAR data subset pairs;
defining a matrix with entries for each sequential SAR data subset pair, wherein observed SAR data subset pairs are represented by ones and unobserved SAR data subset pairs are represented by zeros; and
calculating estimated coherence values for the unobserved SAR data subset pairs by finding a least square solution of a matrix equation using the defined matrix and logarithmic values determined from the calculated observed coherence values for the observed SAR data subset pairs, wherein the calculated observed coherence values and calculated estimated coherence values are provided to the trained crop growth estimation model.
